(19) United States
(12) Patent Application Publication
(10) Pub. No.: US 2013/0185483 A1
(43) Pub. Date: Jul. 18, 2013

(54) DATA STORAGE SYSTEM, MEMORY CONTROLLER, NONVOLATILE MEMORY DEVICE, AND METHOD OF OPERATING THE SAME

(71) Applicant: Samsung Electronics Co., Ltd., Suwon-si (KR)

(72) Inventors: DU-WON HONG, SUWON-SI (KR); JIN-YEONG KIM, SUWON-SI (KR); JUNG-YEON YOON, HWASEONG-SI (KR)

(73) Assignee: SAMSUNG ELECTRONICS CO., LTD., SUWON-SI (KR)

(21) Appl. No.: 13/739,417

(22) Filed: Jan. 11, 2013

(30) Foreign Application Priority Data
Jan. 17, 2012 (KR) 10-2012-0005326

(51) Int. Cl. G06F 12/02

(52) U.S. Cl. CPC G06F 12/0246
USPC 711/103

(57) ABSTRACT

A nonvolatile memory device includes: first through m-th word lines arranged sequentially and first through m-th pages connected respectively to the first through m-th word lines; a redundant array of inexpensive disks (RAID) controller generating first RAID parity data from first through (m−1)-th data; and an access controller connected to the RAID controller and capable of accessing the nonvolatile memory device, wherein the access controller programs the first through (m−1)-th data to the first through (m−1)-th pages and programs the first RAID parity data to the m-th page.

This application claims priority from Korean Patent Application No. 10-2012-0005326 filed on Jan. 17, 2012 in the Korean Intellectual Property Office, the disclosure of which is incorporated herein by reference in its entirety.

### BACKGROUND

The present inventive concept relates to a data storage system, a memory controller, and a nonvolatile memory device.

Redundant array of inexpensive disks (RAID) is used mostly by servers that store important data. RAID is a method of redundantly storing the same data in different places. RAID can strike a balance between input and output and improve the overall performance of a server.

Meanwhile, solid state drives (SSDs) are replacing hard disk drives (HDDs). A semiconductor memory used in an SSD may be a NAND flash memory. The reliability of the NAND flash may deteriorate as the number of program/erase (P/E) cycles increases.

### SUMMARY

Aspects of the present inventive concept provide a data storage system whose reliability can be guaranteed even if a program/erase (P/E) cycle increases.

Aspects of the present inventive concept also provide a memory controller whose reliability can be guaranteed even if the P/E cycle increases.

Aspects of the present inventive concept also provide a nonvolatile memory device whose reliability can be guaranteed even if the P/E cycle increases.

However, aspects of the present inventive concept are not restricted to the ones set forth herein. The above and other aspects of the present inventive concept will become more apparent to one of ordinary skill in the art to which the present inventive concept pertains by referencing the detailed description of the present inventive concept given below.

According to an aspect of the present inventive concept, there is provided a nonvolatile memory device comprising first through m-th word lines arranged sequentially and first through m-th pages connected respectively to the first through m-th word lines; a redundant array of inexpensive disks (RAID) controller generating first RAID parity data using first through (m−1)-th data; and an access controller connected to the RAID controller and capable of accessing the nonvolatile memory device, wherein the access controller programs the first through (m−1)-th data to the first through (m−1)-th pages and programs the first RAID parity data to the m-th page.

According to another aspect of the present inventive concept, there is provided a memory controller comprising: a RAID controller generating first RAID parity data using first through (m−1)-th data; and an access controller connected to the RAID controller and capable of accessing a nonvolatile memory device which comprises first through m-th word lines arranged sequentially and first through m-th pages connected respectively to the first through m-th word lines, wherein the access controller programs the first through (m−1)-th data to the first through (m−1)-th pages and programs the first RAID parity data to the m-th page.

According to another aspect of the present inventive concept, a method comprises: providing a nonvolatile memory device which includes first through m-th word lines arranged sequentially and first through m-th pages connected respectively to the first through m-th word lines; receiving first through (m−1)-th data; generating first RAID parity data for the first through (m−1)-th data; programming the first through (m−1)-th data to a nonvolatile memory device which includes first through m-th word lines arranged sequentially, and first through m-th pages connected respectively to the first through m-th word lines, wherein the first through (m−1)-th data is programmed to the first through (m−1)-th pages; and programming the first RAID parity data to the m-th page.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a block diagram of a data storage system 100 according to some embodiments of the present inventive concept.

FIG. 2 is a block diagram illustrating the configuration of an embodiment of a nonvolatile memory device 30 shown in FIG. 1.

FIG. 3 is a block diagram illustrating an embodiment of a data storage method of the data storage system 100 shown in FIG. 1.

FIG. 4 is a diagram illustrating an example data storage method used by data storage system 100 of FIG. 1.

FIGS. 5 and 6 are diagrams illustrating other example data storage methods used by data storage system 100 of FIG. 1.

FIG. 7 is a diagram illustrating another example data storage method used by data storage system 100 of FIG. 1.

FIG. 8 is a block diagram of an example of a memory controller 20 shown in FIG. 1.

### DETAILED DESCRIPTION OF THE EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art. The same reference numbers indicate the same components throughout the specification. In the attached figures, the thickness of layers and regions is exaggerated for clarity.

It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

The present invention will be described with reference to perspective views, cross-sectional views, and/or plan views, in which preferred embodiments of the invention are shown. Thus, the profile of an exemplary view may be modified according to manufacturing techniques and/or allowances. That is, the embodiments of the invention are not intended to limit the scope of the present invention but cover all changes and modifications that can be caused due to a change in manufacturing process. Thus, regions shown in the drawings are illustrated in schematic form and the shapes of the regions are presented simply by way of illustration and not as a limitation.

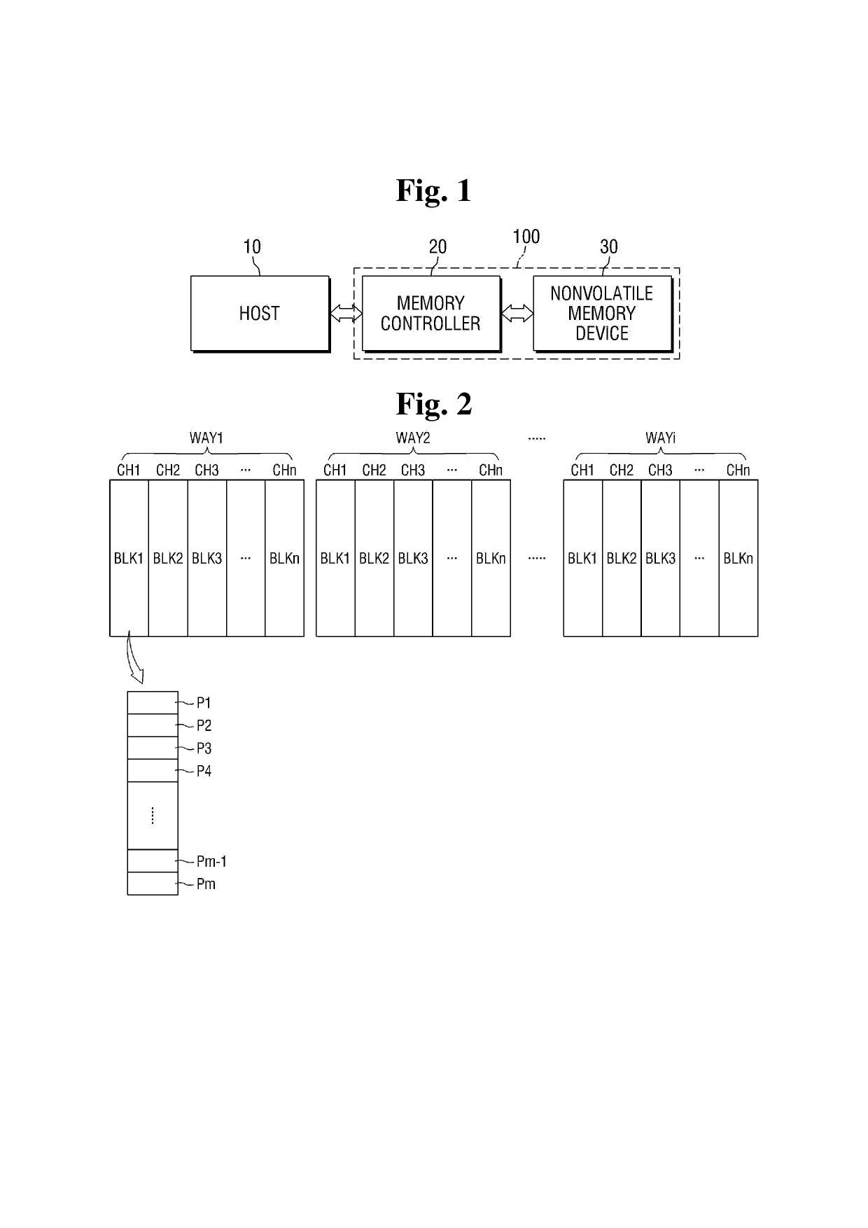

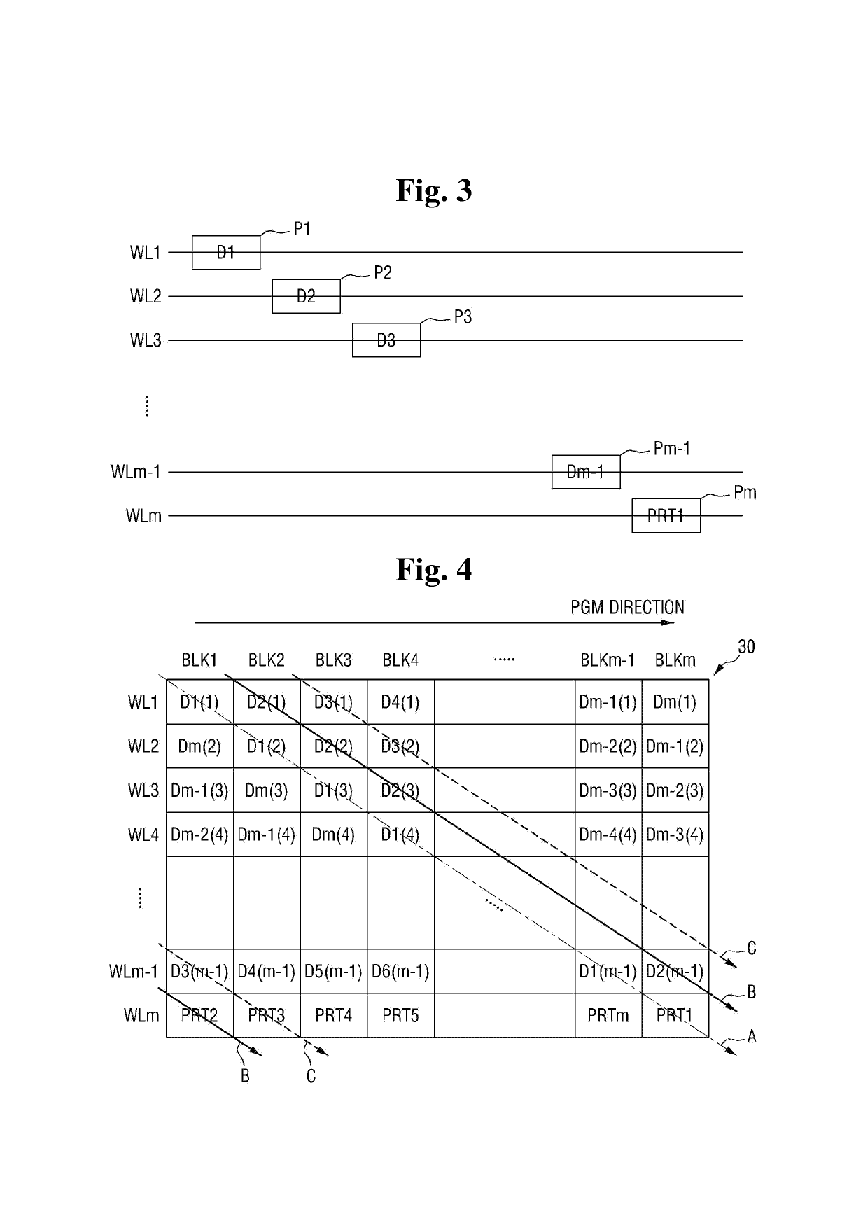

FIG. 1 is a block diagram of a data storage system 100 according to some embodiments of the present inventive concept. FIG. 2 is a block diagram illustrating the configuration of an embodiment of a nonvolatile memory device 30 shown in FIG. 1. FIG. 3 is a block diagram illustrating an embodiment of a data storage method of the data storage system 100 shown in FIG. 1.

Referring to FIG. 1, the data storage system 100 according to the embodiments of the present inventive concept may adopt, but is not limited to, an internal redundant array of inexpensive disks (RAID) and error correction code (ECC). Here, external RAID may denote redundantly storing the same data in a plurality of independent semiconductor chips, and internal RAID may denote redundantly storing the same data in one semiconductor chip.

A RAID to be described below may have various levels. For example, the RAID may have any one of RAID level 0 (striped set without parity or striping), RAID level 1 (mirrored set without parity or mirroring), RAID level 2 (hamming code parity), RAID level 3 (striped set with dedicated parity, bit interleaved parity, or byte level parity), RAID level 4 (block level parity), RAID level 5 (striped set with distributed parity or interleave parity), RAID level 6 (striped set with dual distributed parity), RAID level 7, RAID level 10 and RAID level 53, or a RAID level (e.g., RAID 0+1, RAID 1+0, RAID 5+0, RAID 5+1, or RAID 0+1+5) obtained by merging at least two of the above RAID levels.

Data storage system 100 may include a memory controller 20 and nonvolatile memory device 30.

In a read operation, the memory controller 20 may transmit data read from nonvolatile memory device 30 to a host 10 in response to a read command output from host 10.

In a programming operation (or a write operation), memory controller 20 may write (or program) data output from the 10 to the nonvolatile memory device 30 in response to a program command (or a write command) output from host 10.

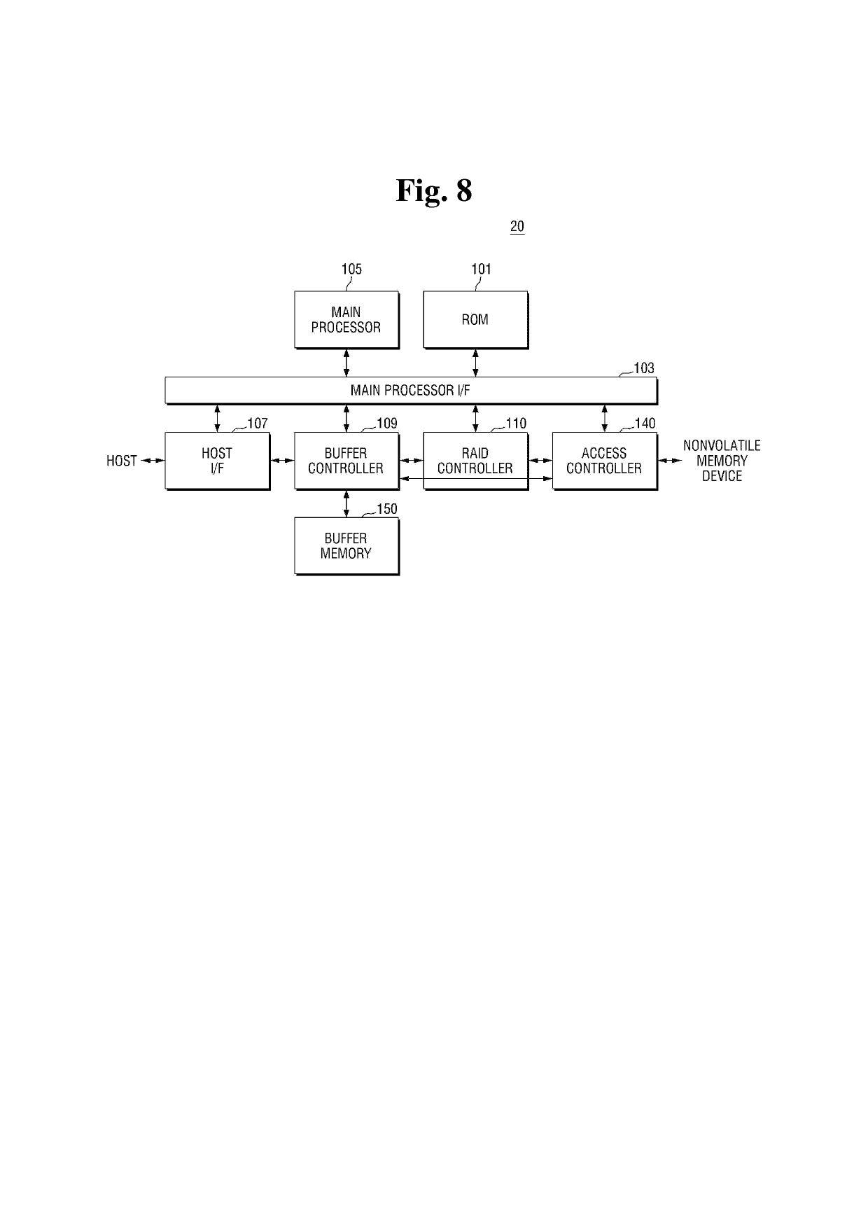

Memory controller 20 may generate RAID parity data based on data output from host 10. For example, memory controller 20 may generate RAID parity data by performing an XOR operation on multiple data received from host 10. In addition, memory controller 20 may store the received data and the RAID parity data in nonvolatile memory device 30 using any one of methods which will be described in detail later with reference to FIGS. 3 through 7. An example structure of memory controller 20 will be described in detail later with reference to FIG. 8.

Referring to FIG. 2, nonvolatile memory device 30 includes a plurality of memory blocks BLK1 through BLKn, where n is a natural number. As shown in the drawing, the memory blocks BLK1 through BLKn may correspond to a plurality of channels CH1 through CHn, where n is a natural number. Here, each of the channels CH1 through CHn may be at least one data line through which data and RAID parity data are transmitted.

Nonvolatile memory a device 30 includes a plurality of ways WAY1 through WAYi, where i is a natural number. The ways WAY1 through WAYi may be memory banks. Therefore, i ways shown in FIG. 2 may indicate that i memory banks can be connected to memory controller 20.

Each of the memory blocks BLK1 through BLKn may include first through m^{th} pages P1 through Pm, where m is a natural number. For example, when memory cells used in nonvolatile memory device 30 are single level cells, each of the memory blocks BLK1 through BLKn may include 64 pages. When the memory cells are multilevel cells, each of the memory blocks BLK1 through BLKn may include 128 pages. When the memory cells are triple level cells, each of the memory blocks BLK1 through BLKn may include 192 pages.

The memory cells used in nonvolatile memory device 30 may be configured as a flash memory, an electrically erasable programmable read-only memory (EEPROM), a magnetic random access memory (MRAM), a spin-transfer torque MRAM, a conductive bridging RAM (CBRAM), a ferroelectric RAM (FeRAM), a phase change RAM(PRAM) also called an ovonic unified memory (OUM), a resistive RAM (RRAM or ReRAM), a nanotube RRAM, a polymer RAM (PoRAM), a nano floating gate memory (NFGM), a holographic memory, a molecular electronics memory device or an insulator resistance change memory.

Referring to FIG. 3, nonvolatile memory device 30 may include first though m^{th} word lines WL1 through WLm arranged sequentially, and the first through m^{th} pages P1 through Pm connected respectively to the first through m^{th} word lines WL1 through WLm. That is, the first through m^{th} pages P1 through Pm may be connected to different word lines WL1 through WLm, respectively. The first through m^{th} pages P1 through Pm may be placed in different memory blocks, i.e., the first through m^{th} memory blocks BLK1 through BLKm, respectively. However, the present inventive concept is not limited thereto. For example, the first through m^{th} pages P1 through Pm can also be placed in one memory block.

Memory controller 20 may generate first RAID parity data PRT1 using first through (m−1)^{th} data D1 through Dm−1. For example, memory controller 20 may generate the first RAID parity data PRT1 by performing an XOR operation on the first through (m−1)^{th} data D1 through Dm−1. Memory controller 20 may program the first through (m−1)^{th} data to the first through (m−1)^{th} pages P1 through Pm−1and program the first RAID parity data PRT1 to the m^{th} page Pm.

The reason why the first through (m−1)^{th} data D1 through Dm−1and the first RAID parity data PRT1 are stored in pages connected to different word lines, that is, in the first through (m−1)^{th} pages P1 through Pm−1connected to the first through (m−1)^{th} word lines WL1 through WLm−1and the m^{th} page Pm connected to the m^{th} word line WLm, is as follows.

The reliability of a nonvolatile memory cell (e.g., a NAND flash memory cell) may depend on the position thereof in a memory block BLK1 through BLKn. For example, the reliability of a page located in the middle of each memory block BLK1 through BLKn may be lower than that of pages located at other positions. That is, a page connected to a certain word line may have poor characteristics, and this phenomenon may worsen as the number of program/erase (P/E) cycles increases.

If the first through (m−1)^{th} data D1 through Dm−1and the first RAID parity data PRT1 are all stored in a page (e.g., P1) connected to the same word line (e.g., WL1), when characteristics of the first page P1 connected to the first word line WL1 deteriorate noticeably, data recovery is impossible.

However, if the first through (m−1)^{th} data D1 through Dm−1and the first RAID parity data PRT1 are stored in the pages P1 through Pm−1and Pm connected to the different word lines WL1 through WLm−1and WLm as according to embodiments of the present inventive concept, data recovery is easy. For example, even if an error occurs in the first data D1 stored in the first page P1 connected to the first word line WL1, the first data D1 can be recovered using the second through (m−1)^{th} data D2 through Dm−1and the first RAID parity data PRT1 stored in the pages P2 through Pm connected to the other word lines WL2 through WLm. Therefore, even if the number of P/E cycles increases, the reliability of data storage system 100 according to embodiments of the present inventive concept can be guaranteed, which, in turn, increases the life of data storage system 100.

Data storage system 100 may form a solid state drive (SSD).

Alternatively, data storage system 100 may be integrated as one semiconductor device to form a memory card such as a personal computer (PC) card (e.g., personal computer memory card international association (PCMCIA) card), a compact flash (CF) card, a smart media card (SM/SMC), a memory stick, a multimedia card (e.g., MMC, RS-MMC, MMCmicro), an SD card (e.g., SD, miniSD, microSD, SDHC), or a universal flash storage (UFS) device.

As another example, data storage system 100 may be one of various components of electronic devices such as computers, ultra-mobile PCs (UMPCs), workstations, net-books, personal digital assistants (PDAs), portable computers, web tablets, wireless phones, mobile phones, smart phones, e-books, portable multimedia players (PMPs), portable game devices, navigation devices, black boxes, digital cameras, three-dimensional televisions, digital audio recorders, digital audio players, digital picture recorders, digital picture players, digital video recorders, digital video players, devices capable of transmitting/receiving information in wireless environments, one of various electronic devices constituting a home network, one of various electronic devices constituting a computer network, one of various electronic devices constituting a telematics network, a radio frequency identification (RFID) device, or one of various components constituting a computing system.

Data storage system 100 may be mounted in various types of packages. For example, data storage system 100 may be packaged using various methods such as Package on Package (PoP), Ball Grid Arrays (BGAs), Chip Scale Packages (CSPs), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), Thin Quad Flat Pack (TQFP), System In Package (SIP), Multi Chip Package (MCP), Wafer-level Fabricated Package (WFP), and Wafer-level Processed Stack Package (WSP).

FIG. 4 is a diagram illustrating an example data storage method which may be used by data storage system 100 of FIG. 1.

Referring to FIG. 4, nonvolatile memory device 30 may include first through m^{th} memory blocks BLK1 through BLKm arranged sequentially, first through m^{th} word lines WL1 through WLm intersecting the first through m^{th} memory blocks BLK1 through BLKm and arranged sequentially, and m×m pages defined at intersections of the first through m^{th} blocks BLK1 through BLKm and the first through m^{th} word lines WL1 through WLm. In FIG. 4, m memory blocks BLK1 through BLKm and m word lines WL1 through WLm are illustrated as an example. However, the present inventive concept is not limited to this example. For example, s (s is a natural number different from m) pages may be connected to one word line (e.g., WLm).

For ease of description, a page defined at an intersection of the first word line WL1 and the first memory block BLK1 will be written as P(WL1, BLK1).

A programming operation may be performed in a direction indicated by arrows (that is, from the left to the right of the drawing). That is, pages P(WL1, BLK1) through P(WL1, BLKm) corresponding to the first word line WL1 may be programmed, and then pages P(WL2, BLK1) through P(WL2, BLKm) corresponding to the second word line WL2 may be programmed. In this way, all pages up to and including pages P(WLm−1, BLK1) through P(WLm−1, BLKm) corresponding to the (m−1)^{th} word line WLm−1 are programmed.

Then, first through m^{th} RAID parity data PRT1 through PRTm are programmed respectively into pages P(WLm, BLK1) through P(WLm, BLKm) corresponding to the m^{th} word line WLm. As shown in the drawing, the first through m^{th} RAID parity data PRT1 through PRTm may be programmed in order of PRT2, PRT3, PRT4, PRT5, ˜, PRTm, and PRT1.

For example, referring to arrow A, the first RAID parity data PRT1 may be generated using first through (m−1)^{th} data D1(1) through D1(m−1). For example, the first RAID parity data PRT1 may be generated by performing an XOR operation on the first through (m−1)^{th} data D1(1) through D1(m−1).

Referring to arrow B, the second RAID parity data PRT2 may be generated using first through (m−1)^{th} data D2(1) through D2(m−1). For example, the second RAID parity data PRT2 may be generated by performing an XOR operation on the first through (m−1)^{th} data D2(1) through D2(m−1).

Referring to arrow C, the third RAID parity data PRT3 may be generated using first through (m−1)^{th} data D3(1) through D3(m−1). For example, the third RAID parity data PRT3 may be generated by performing an XOR operation on the first through (m−1)^{th} data D3(1) through D3(m−1).

As described above, in embodiments of the present inventive concept, the m pages P(WLm, BLK1) through P(WLm, BLKm) may be connected to the m^{th} word line WLm, and the first through m^{th} RAID parity data PRT1 through PRTm may respectively be stored in the pages P(WLm, BLK1) through P(WLm, BLKm).

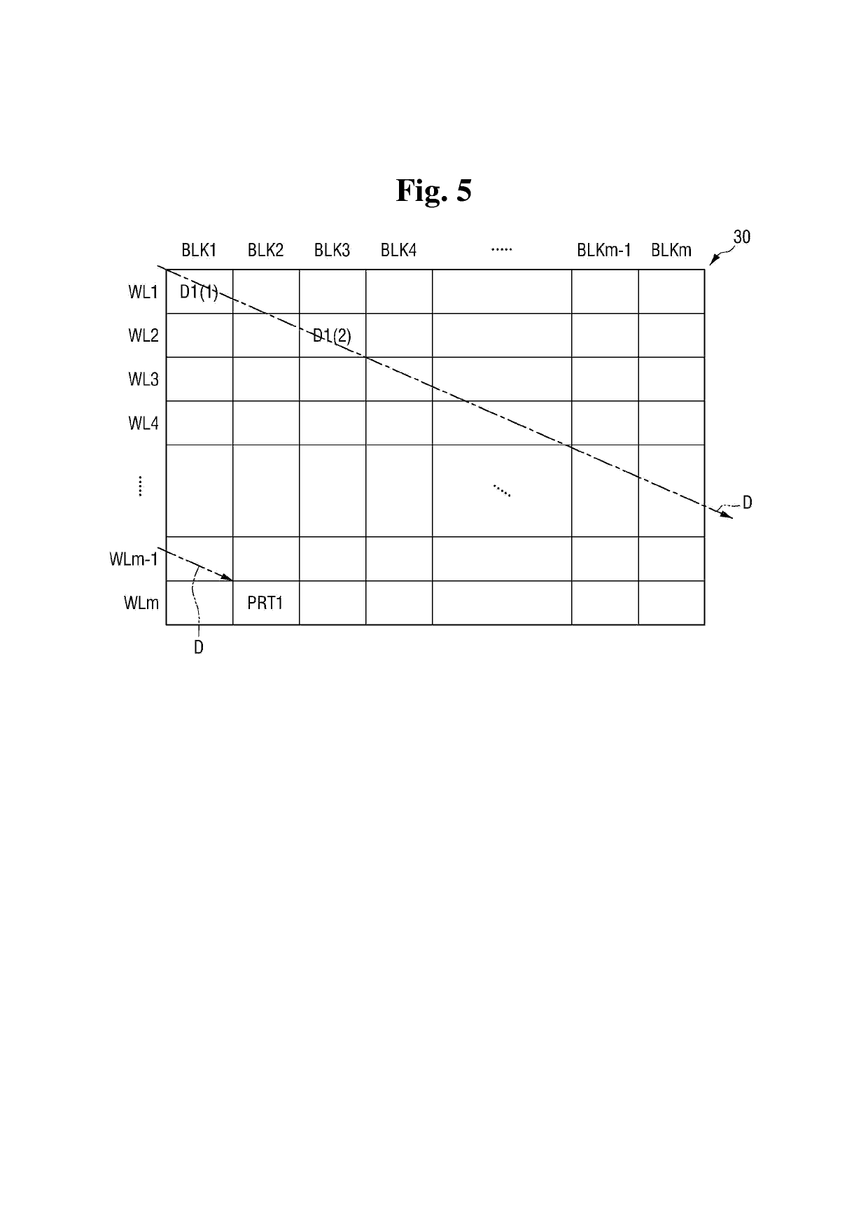

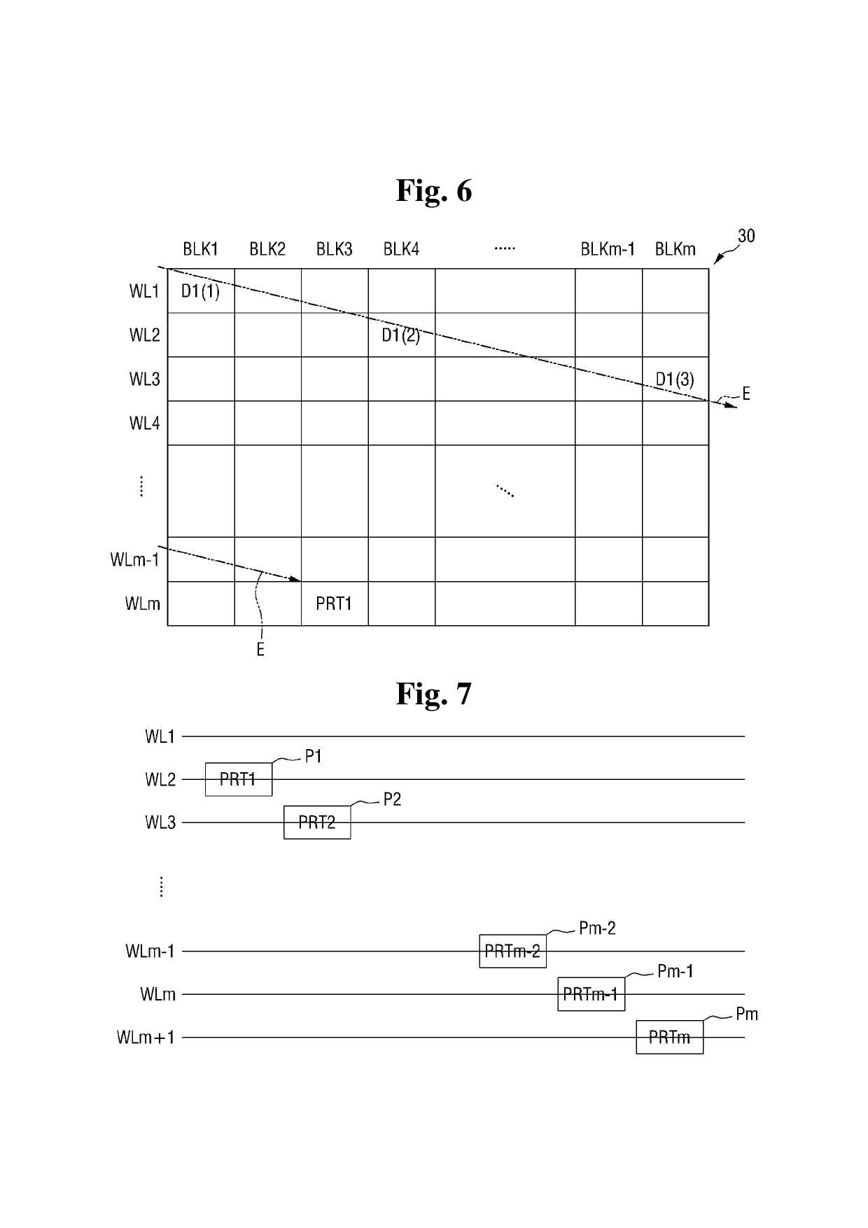

FIGS. 5 and 6 are diagrams illustrating other example data storage methods which may be used by data storage system 100 of FIG. 1. The following description will focus on differences from the data storage method described above with reference to FIG. 4.

Referring to FIG. 4, the first RAID parity data PRT1 may be generated using the first through (m−1)^{th} data D1(1) through D1(m−1). Here, the first through (m−1)^{th} data D1(1) through D1(m−1) are respectively stored in the first through m^{th} memory blocks BLK1 through BLKm which are adjacent to each other.

Referring to FIGS. 5 and 6, the first RAID parity data PRT1 may be generated using the first through (m−1)^{th} data D1(1) through D1(m−1). The first through (m−1)^{th} data D1(1) through D1(m−1) are respectively stored in the first through m^{th} memory blocks BLK1 through BLKm which are separated from each other (i.e., not adjacent to each other). That is, of the first through (m−1)^{th} data D1(1) through D1(m−1), the q^{th} data (1<q<m−1, where q is a natural number) and the (q+1)^{th} data are stored in memory blocks which are separated from each other.

In FIG. 5, one memory block is placed between a memory block which stores the q^{th} data (1≦q≦m−1, where q is a natural number) and a memory block which stores the (q+1)^{th} data (see arrow D). For example, D1(1) is stored in the first memory block BLK1, and D1(2) is stored in the third memory block BLK3.

In FIG. 6, two memory blocks are placed between a memory block which stores the q^{th} data (1≦q≦m−1, where q is a natural number) and a memory block which stores the (q+1)^{th} data (see arrow E). For example, D1(1) is stored in the first memory block BLK1, and D1(2) is stored in the fourth memory block BLK4.

FIG. 7 is a diagram illustrating another example data storage method which may be used by data storage system 100 of FIG. 1. The following description will focus on differences from the data storage method described above with reference to FIG. 4.

Referring to FIG. 4, the first through m^{th} RAID parity data PRT1 through PRTm are respectively stored in pages P(WLm, BLK1) through P(WLm, BLKm) connected to one word line WLm.

On the other hand, referring to FIG. 7, the first through m^{th} RAID parity data PRT1 through PRTm may be stored in pages P1 through Pm connected to different word lines WL2 through WLm+1, respectively. The data storage method illustrated in FIG. 7 is merely an example, and the present inventive concept is not limited to this example.

FIG. 8 is a block diagram of an example of memory controller 20 shown in FIG. 1.

Referring to FIG. 8, memory controller 20 may include a read-only memory (ROM) 101, a main processor interface 103, a main processor 105, a host interface 107, a buffer controller 109, a RAID controller 110, an access controller 140, and a buffer memory 150.

Main processor 105 may interpret an access command (e.g., a write command, a program command, a read command or an erase command) output from a host and control the operation of each component 107, 109, 110, 140 or 150 based on the interpretation result.

When memory controller 20 does not include buffer controller 109, host interface 107 may perform an interfacing operation between the host and RAID controller 110. On the other hand, when memory controller 20 includes buffer controller 109, then host interface 107 may perform an interfacing operation between the host and buffer controller 109.

When receiving first through (m−1)^{th} data D1(1) through D1(m−1) (see FIG. 4) from the host, buffer memory 150 may store the received first through (m−1)^{th} data D1(1) through D1(m−1).

RAID controller 110 generates first RAID parity data PRT1 using the first through (m−1)^{th} data D1(1) through D1(m−1). For example, RAID controller 110 may generate the first RAID parity data PRT1 by performing an XOR operation on the first through (m−1)^{th} data D1(1) through D1(m−1). However, the present inventive concept is not limited thereto.

Access controller 140 may be connected to RAID controller 110 and access a nonvolatile memory device. When the nonvolatile memory device is configured as a NAND flash memory, access controller 140 may be configured as a NAND flash controller. As described above, access controller 140 may program the first through (m−1)^{th} data D1(1) through D1(m−1) to first through (m−1)^{th} pages P(WL1, BLK1), P(WL2, BLK2), ˜, P(WLm−1, BLKm−1) (see FIG. 4) and program the first RAID parity data PRT1 to an m^{th} page (P(WLm, BLKm) (see FIG. 4).

Buffer memory 150 may store all of the first through (m−1)^{th} data D1(1) through D1(m−1).

Alternatively, buffer memory 150 may store a value of an XOR operation, so that the amount of data stored in buffer memory 150 can be reduced.

For example, if the first through (m−1)^{th} data D1(1) through D1(m−1) are input sequentially, when w^{th} data (1≦w≦m−1, where w is a natural number) is input, buffer memory 150 may store a value produced by an XOR operation performed on the first through w^{th} data D1(1) through D1(w). Specifically, when the second data D1(2) is input, D1(1)⊕D1(2) may be stored in buffer memory 150. When the third data D1(3) is input, D1(1)⊕D1(2)⊕D1(3) may be stored in buffer memory 150. The XOR operation may be performed by RAID controller 110.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A data storage system comprising:
a nonvolatile memory device comprising first through m-th word lines arranged sequentially, and first through m-th pages connected respectively to the first through m-th word lines;
a redundant array of inexpensive disks (RAID) controller generating first RAID parity data using first through (m−1)-th data; and
an access controller connected to the RAID controller and capable of accessing the nonvolatile memory device, wherein the access controller programs the first through (m−1)-th data to the first through (m−1)-th pages and programs the first RAID parity data to the m-th page.

2. The data storage system of claim 1, wherein the first through m-th pages are arranged in first through m-th memory blocks, respectively.

3. The data storage system of claim 2, wherein the first through m-th memory blocks are arranged sequentially.

4. The data storage system of claim 2, wherein of the first through (m−1)-th data, q-th data and (q+1)-th data are stored in memory blocks which are separated from each other by at least one memory block, wherein 1≦q≦m−1, where q is a natural number.

5. The data storage system of claim 1, further comprising a buffer memory storing the first through (m−1)-th data.

6. The data storage system of claim 1, further comprising a buffer memory storing a value produced by an XOR operation performed on the first through w-th data when the w-th data is input in a case where the first through (m−1)-th data are input sequentially, wherein 1≦w≦m−1, where w is a natural number.

7. The data storage system of claim 1, wherein s pages are connected to the m-th word line, and first through s-th RAID parity values are respectively stored in the s pages, wherein s is a natural number.

8. The data storage system of claim 1, comprising a solid state drive (SSD).

9. A memory controller comprising:
a RAID controller generating first RAID parity data using first through (m−1)-th data; and
an access controller connected to the RAID controller and capable of accessing a nonvolatile memory device which comprises first through m-th word lines arranged sequentially and first through m-th pages connected respectively to the first through m-th word lines,
wherein the access controller programs the first through (m−1)-th data to the first through (m−1)-th pages and programs the first RAID parity data to the m-th page.

10. The memory controller of claim 9, wherein the first through m-th pages are arranged in first through m-th memory blocks, respectively.

11. The memory controller of claim 10, wherein the first through m-th memory blocks are arranged sequentially.

12. The memory controller of claim 10, wherein of the first through (m−1)-th data, q-th data and (q+1)-th data are stored in memory blocks which are separated from each other by at least one memory block, wherein 1≦q≦m−1, where q is a natural number.

13. The memory controller of claim 9, wherein s pages are connected to the m-th word line, and first through s-th RAID parity values are respectively stored in the s pages, wherein s is a natural number.

14. The memory controller of claim 9, further comprising a buffer memory storing the first through (m−1)-th data.

15. The memory controller of claim 9, further comprising a buffer memory storing a value produced by an XOR operation performed on the first through w-th data when the w-th data is input in a case where the first through (m−1)-th data are input sequentially, wherein 1≦w≦m−1, where w is a natural number.

16. A method, comprising:
providing a nonvolatile memory device which includes first through m-th word lines arranged sequentially and first through m-th pages connected respectively to the first through m-th word lines;
receiving first through (m−1)-th data;
generating first RAID parity data for the first through (m−1)-th data;
programming the first through (m−1)-th data to a nonvolatile memory device which includes first through m-th word lines arranged sequentially, and first through m-th pages connected respectively to the first through m-th word lines, wherein the first through (m−1)-th data is programmed to the first through (m−1)-th pages; and
programming the first RAID parity data to the m-th page.

17. The method of claim 16, wherein the first through m-th pages are arranged in first through m-th memory blocks, respectively.

18. The method of claim 17, wherein the first through m-th memory blocks are arranged sequentially.

19. The method of claim 17, wherein of the first through (m−1)-th data, q-th data and (q+1)-th data are stored in memory blocks which are separated from each other, wherein 1<q<m−1, where q is a natural number.

20. The method of claim 16, wherein s pages are connected to the m-th word line, and first through s-th RAID parity values are respectively stored in the s pages, wherein s is a natural number.
